(19) United States
(12) Patent Application Publication
(10) Pub. No.: US 2004/0217584 A1
(43) Pub. Date: Nov. 4, 2004

(54) Oracle Book

(76) Inventor: Adam Matthew Holms, Goleta, CA (US)

Correspondence Address: MICHAEL G PETIT, 123 W PADRE ST., SUITE F, P O BOX 91929, SANTA BARBARA, CA, 93190

(21) Appl. No.: 10/709,020

(22) Filed: Apr. 7, 2004

Related U.S. Application Data
(60) Provisional application No. 60/467,023, filed on Apr. 29, 2003.

(51) Int. Cl. B42D 1/00

(52) U.S. Cl. 281/15.1

(57) ABSTRACT

A device for assisting thought processes in decision making. The device is a book having a front cover bearing a title in characters and a rear cover bearing the title but wherein the characters comprising the title are inverted with respect to the front cover. Thus, the book may be opened sensibly from either the front or the back. A plurality of pages, each page bearing self-contained text, are disposed between the front and rear covers with the text inverted on alternate pages. A person contemplates a problem then opens the book either from the front or the rear to reveal a random page. The text that appears in non-inverted characters on the exposed page is read to provide guidance in solving the problem.

### CROSS REFERENCE TO RELATED APPLICATIONS

This application claims priority to U.S. Provisional Patent Application Ser. No. 60/467,023 entitled ORACLE BOOK filed on Apr. 29, 2003.

### BACKGROUND OF INVENTION

1. Field of the Invention

The present invention relates to a device for providing guidance in a decision making process and, more particularly, to a book having a plurality of pages, each alternate page bearing text that is self-contained and inverted with respect to the text contained on an adjacent page.

2. Prior Art

“Magic Cubes” and the like are well known in the art as aids in making a decision or answering a question. In order to use such devices, a question is formulated within the mind of the user. The “Magic Cube” or the like is then shaken or rotated to display one of a plurality of possible answers. The displayed “answer” may be useful for arriving at a correct answer. It is both fun and occasionally even helpful to use such devices when considering a problem. There is a need for such a device that presents many different independent texts to provide different approaches for problem solving.

### SUMMARY OF INVENTION

It is an object of the present invention to provide a device that enables a decision maker to consider one or more potentially viable ideas for application to problem solving.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF DRAWINGS

FIG. 1 is a top view of an oracle book in accordance with the present invention.

FIG. 2 is a bottom view of the oracle book of FIG. 1.

FIG. 3 is a top view of the oracle book of FIGS. 1 and 2 opened to a page bearing text.

### DETAILED DESCRIPTION

Turning now to FIG. 1, an oracle book 10 in accordance with the present invention is illustrated in top view. The book 10 has a front cover 11 having a title 12 printed thereon. The characters 13 comprising the title are upright and legible.

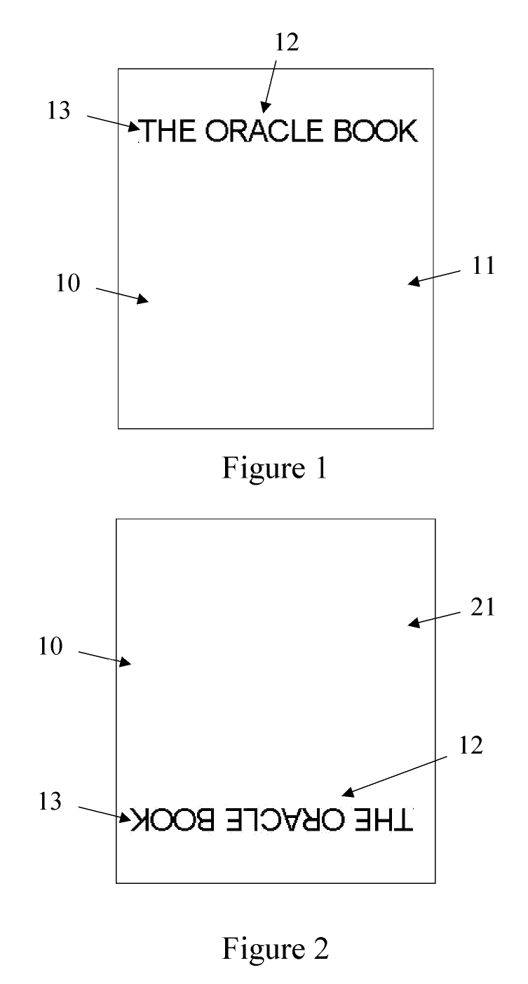

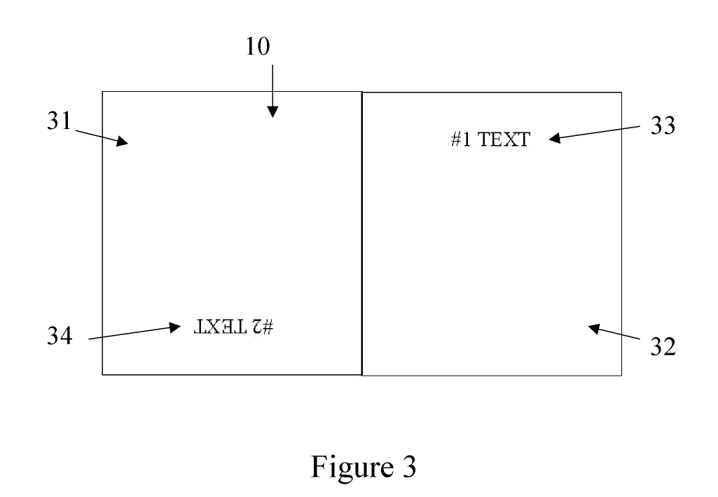

The book 10 of FIG. 1 is shown in rear view in FIG. 2 in a position obtained by turning the book 10 of FIG. 1 over from right to left (or left to right). The rear cover 21 bears the same title 12 as the front cover but is inverted. FIG. 3 illustrates adjacent pages 31 and 32 of the book 10 when the book of FIG. 1 is opened by lifting the front cover 11. The text (#1 TEXT) 33 appearing on the page 32 is upright and legible while the text (#2 TEXT) 34 appearing on the adjacent page 31 is inverted and illegible. The user (i.e., a person seeking an answer to a posit or course of action required to solve a problem) picks either the front 11 or rear cover 21 to place in an upright position then opens the book 10 to a randomly selected page. The TEXT indicated on the open page may be a useful adjunct for consideration and may even suggest a solution to the problem.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What I claim is:

1. A book comprising a front cover, a back cover, a plurality of pages therebetween, and a spine, said covers and said pages comprising a left facing surface and a right facing surface with respect to said spine, wherein said front cover, said back cover and said plurality of pages contain graphical characters such that said graphical characters are configured in an upright position on said right facing surface and are inverted on said left facing surface.

2. A book as in claim 1 wherein said graphical characters comprise text and pictures and wherein said text is written in a single language.

3. A book as in claim 1 wherein said graphical characters on said right facing surface are the same as said graphical characters on said left facing surface.

4. A book as in claim 2 wherein said graphical characters on said right facing surface are the same as said graphical characters on said left facing surface.
